(19) United States
(12) Patent Application Publication
(10) Pub. No.: US 2017/0063471 A1
(43) Pub. Date: Mar. 2, 2017

(54) AUDIO SIGNAL TRANSMISSION SYSTEM WITH ENHANCED AUDIO SIGNAL RECOGNITION AND DATA PROCESSING METHOD FOR THE SAME

(71) Applicant: RED SUNRISE CO., LTD., Taipei (TW)

(72) Inventor: Yu-Hung Chen, Taipei (TW)

(21) Appl. No.: 14/839,033

(22) Filed: Aug. 28, 2015

(51) Int. Cl. H04B 11/00; G08C 23/02; H04L 1/00

(52) U.S. Cl. CPC H04B 11/00; H04L 1/009; G08C 23/02

(57) ABSTRACT

An audio signal transmission system includes a first device and a second device. The first device transmits audio signals to the second device for the second device to process the audio signals and recognize data in the audio signals. After converting a piece of information read by the first device into digital data, the first device performs data state conversion algorithm to generate a time-based byte sequence, modulates the byte sequence to a set of audio signals, and transmits the set of audio signals. When receiving the set of audio signals, the second device filters and demodulates the set of audio signals to acquire the byte sequence, and converts the byte sequence into readable information. As the byte sequence has time-based characteristics, multiple independent pulse signals can be constantly provided to enhance audio signal recognition and ensure accuracy and stability of the audio signal transmission system.

### BACKGROUND OF THE INVENTION

1. Field of the Invention

The present invention relates to an audio signal transmission system and, more particularly, to an audio signal transmission system with enhanced audio signal recognition and a data processing method of the audio signal transmission system.

2. Description of the Related Art

Owing to the progress of science and technology, using mobile device to transmit and receive information through mobile communication or wireless communication has become a rather commonplace technique. Recently, the technique of transmitting data over sound wave, such as data over sonic wave (DSW), is also available. Also given transmission of URL (Uniform Resource Locator) information as an example, mobile phones can be taken by users to approach televisions so as to receive a wide variety of information associated with the content playing on the televisions, including introduction of a concert, purchase information, electronic coupons offered by retailing stores and the like.

With reference to FIG. 7, a conventional system for transmitting data and control commands over audio wave includes an audio broadcasting device 91 and an audio receiving device 92. Users can operate the audio broadcasting device 91 to input character strings or commands and convert the character strings or commands into an audio file to be broadcasted. The broadcasted audio waves are transmitted over the air to the audio receiving device 92 and are processed by the audio receiving device 92 to acquire the character strings or control commands in the audio waves after the audio waves are received, such that a corresponding action is automatically performed according to the acquired character strings or control commands. Thus, users can control the audio receiving device 92 to perform a requested service by using the audio broadcasting device 92 for audio broadcasting.

As to how to use the audio broadcasting device 91 to transmit the character strings or control commands in the form of audio waves and how to use the audio receiving device 92 to receive the audio waves, with reference to FIGS. 8 and 9, the audio broadcasting device 91 and the audio receiving device 92 are used to perform the following steps. The audio broadcasting device 91 receives a user-inputted character string, converts the character string into binary data, modulates the binary data to a set of audio signals through phase shift keying (PSK) modulation, determines if the set of audio signals is compressed according to a default mode, performs lossy/lossless compression and broadcasts the compressed set of audio signals if positive, and directly broadcasts the set of audio signals if negative. When receiving the set of audio signals, the audio receiving device 92 demodulates the set of audio signals, converts the demodulated set of audio signals into a character string, and determines a next action to be taken according to the character string.

As can be seen from the foregoing steps, if user inputs a character string, such as “NB”, through the audio broadcasting device 91, the audio broadcasting device 91 converts the character string into binary data, such as “00110101”, by way of ASCII code conversion, and modulates the binary data to an audio file using frequency shift modulation (FSK) to transmit the character string over audio waves. However, the FSK technique represents binary data in the form of different frequencies. In other words, frequencies in Fourier transform can be varied to record data. Given frequencies 15 kHz and 18 kHz as an example, when the character string is converted into binary data “00110101”, the bits with 0 are recorded with 15 kHz while the bits with 1 are recorded with 18 kHz. Thus, the audio broadcasting device 91 can record data with two different frequencies.

Furthermore, to reduce data throughput upon data transmission, the audio broadcasting device 91 conducts a lossy compression on the data done with FSK modulation, and represents audio signals and characteristics of the data done with FSK modulation in the form of an original frequency spectrum 93. After the audio broadcasting device 92 performs a lossy compression, such as HE-AAC 64 kbps compression on audio signals, and represents the audio signals in the form of a compressed frequency spectrum 94, despite reduced data throughput after compression, it must be pointed out that the lossy compression algorithm mainly targets at the use of a means of destroying, deleting or modifying part of original audio signals for the purpose of reduced data throughput. Conventionally, the original audio signals are sampled to filter out, integrate or reduce portions of the original audio signals undetected by human beings arising from the audition threshold and masking effect of human ears. However, the resulting audio signals become obscure and noisy with frequency deviation or energy attenuation. After being compressed, the resulting audio signals and characteristics thereof on a frequency spectrum 94 are all obscure and are hard for an analysis. Moreover, when the lossy compression algorithm adjusts bit rate, the lower bit rate adjusted, the more destroyed, deleted or modified data. To human ears, the difference to auditory sense could be minor. However, as far as the audio receiving device 92 is concerned, after receiving audio signals and performing frequency or waveform analysis to read content embedded in the audio signals, the audio receiving device 92 fails to easily recognize the content of the audio signals that are compressed by the lossy compression algorithm.

From the foregoing description, conventional skill utilizes transmission of data over audio signals, which is prone to failure of recognizing content contained in the audio signals at the audio receiving device 92 after the audio signals experience the lossy compression algorithm. Additionally, the conventional DSW techniques also employ the means of frequency modulation using high and low frequencies respectively representing bit values “0” and “1”, and some other conventional techniques adopt PSK modulation using phase angles of waveforms to represent different bit values for data modulation. However, regardless of FSK modulation, PSK modulation or Amplitude Shift Keying (ASK) modulation, after experiencing the lossy compression, waveforms or frequencies of original audio signals will be corrupted, oftentimes causing the failure of the audio receiving device 92 in correctly reading bit values and the issues failure and instability upon transmission.

### SUMMARY OF THE INVENTION

An objective of the present invention is to provide an audio signal transmission system with enhanced audio signal recognition and a data processing method for the same, which perform audio signal transmission between an audio transmitting device and an audio receiving device, process and modulate information to be transmitted, and provide multiple pulse signals to be embedded in the transmitted audio signals to enhance audio signal recognition and increase system accuracy and stability.

To achieve the foregoing objective, the data processing method for an audio signal transmission system with enhanced audio signal recognition, wherein the audio signal transmission system includes a first device and a second device pairing with the first device, and when the first device transmits audio waves to the second device, the data processing method is performed by the first device and includes steps of:

receiving a piece of information;

converting the piece of information into digital data and performing a data state conversion algorithm on the digital data to generate a time-based byte sequence;

adding a header to the byte sequence to constitute a bit sequence;

reading the bit sequence and modulating the bit sequence to a set of audio signals; and

transmitting the set of audio signals to the second device for the second device to receive.

Preferably, the step of adding a header to the byte sequence has a step of adding a header and a check code to the byte sequence to constitute the bit sequence.

Preferably, the data state conversion algorithm sequentially determines binary bits of the digital data according to binary values of the digital data, and when reading any binary bit of the digital data with a value one, the data state conversion algorithm represents the bit with a pulse signal appearing at a corresponding time spot of a time domain through a modulation process.

Preferably, when the first device transmits audio waves to the second device, the data processing method is performed by the second device and has steps of:

receiving the set of audio signals;

converting the set of audio signals to generate audio characteristics of the set of audio signals;

demodulating the converted audio characteristics to acquire digital data, converting the digital data into readable information, and reading the readable information; and

transmitting the readable information to a local side or a remote side.

The foregoing steps occur when the first device transmits audio signals to the second device. When receiving the piece of information and converting the piece of information into the digital data, the first device performs the data state conversion algorithm to generate the time-based byte sequence, such that the byte sequence can constantly provide multiple independent pulse signals for the second device to read content of the piece of information. The first device adds the check code and the header to constitute the bit sequence, modulates the bit sequence to a set of audio signals and transmit the set of audio signals for the second device to receive. After receiving the set of audio signals, the second device just filters and demodulates the set of audio signals to acquire the time-based byte sequence, converts the byte sequence into the readable information, and acquires the piece of information from the readable information. As the byte sequence has time-based characteristics, multiple independent pulse signals can be constantly provided for the second device to rapidly and accurately read, so as to enhance audio signal recognition and ensure accuracy and stability of the audio signal transmission system.

To achieve the foregoing objective, the audio signal transmission system with enhanced audio signal recognition includes a first device and a second device.

The first device has an audio transmitting unit and a first processor.

The first processor is connected to the audio transmitting unit and transmits audio signals through the audio transmitting unit.

The second device has an audio receiving unit and a second processor.

The audio receiving unit receives the audio signals.

The second processor is connected to the audio receiving unit, receives the audio signals transmitted from the audio receiving unit, and processes the audio signals or recognizing data contained in the audio signals.

The first processor of the first device receives a piece of information, converts the piece of information into digital data, performs a data state conversion algorithm on the digital data to generate a time-based byte sequence, adds a header to the byte sequence to constitute a bit sequence, reads the bit sequence and modulates the bit sequence to a set of audio signals, and transmits the set of audio signals to the second device for the second device to receive. The second processor of the second device receives the set of audio signals, converts the set of audio signals to generate audio characteristic of the set of audio signals, demodulates the converted audio characteristics to acquire digital data, converts the digital data into readable information, and reads the readable information.

As can be seen from the foregoing structures, the first processor of the first device transmits a set of processed audio signals containing a piece of information to the second device for the audio receiving unit of the second device to receive. The set of audio signals is transmitted to the second processor for the second processor to perform required audio processing and data recognition. As to the way of processing audio signals, the first processor reads the piece of information, converts the piece of information into the digital data, performs the data state conversion algorithm on the digital data to generate the time-based byte sequence, adds the check code and the header to constitute the bit sequence, modulates the bit sequence to a set of audio signals, and transmits the set of audio signals for the second device to receive. The second device filters and demodulates the set of audio signals to acquire the time-based byte sequence, converts the byte sequence into the readable information, and acquires the piece of information from the readable information. As the byte sequence has time-based characteristics, multiple independent pulse signals can be constantly provided for the second device to rapidly and accurately read, so as to enhance audio signal recognition and ensure accuracy and stability of the audio signal transmission system.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of an audio signal transmission system in accordance with the present invention;

FIG. 2 a schematic diagram of data structures upon data conversion performed by the audio signal transmission system in FIG. 1;

FIG. 3 is a chart diagram showing modulated audio signals and bits therein on the frequency spectrum and audio signals and bits done by lossy compression on the frequency spectrum;

FIG. 4 is a flow diagram of a data processing method performed by the first device of the audio signal transmission system in FIG. 1;

FIG. 5 is a flow diagram of a data processing method performed by a second device of the audio signal transmission system in FIG. 1;

FIG. 6 is a flow diagram of data modulation and conversion algorithm of the second device of the audio signal transmission system in FIG. 1;

FIG. 7 is a functional block diagram of a conventional system for transmitting data and control commands over audio waves;

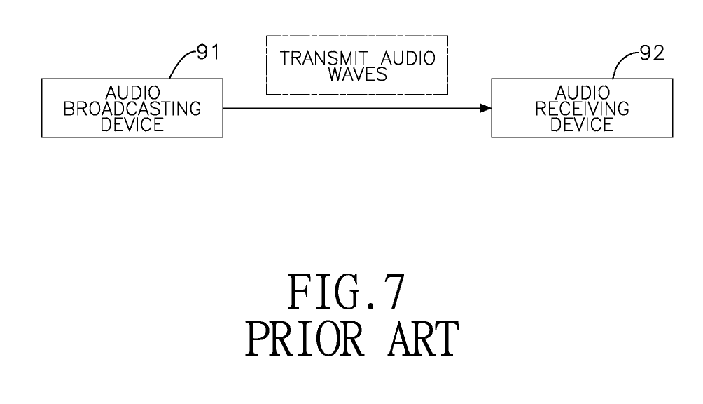

FIG. 8 is a flow diagram of a process of broadcasting audio waves by an audio broadcasting device of the conventional system in FIG. 7;

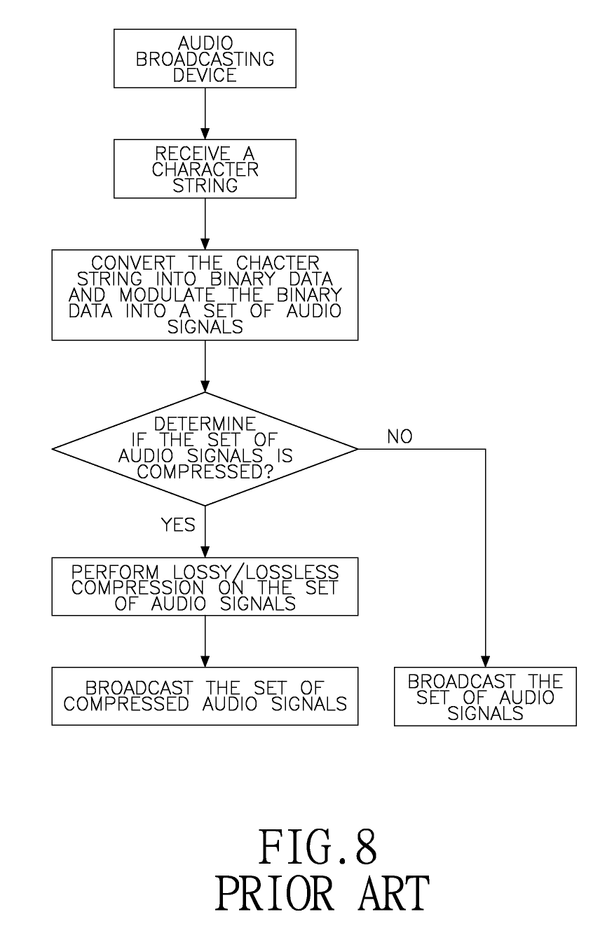

FIG. 9 is a flow diagram of a process of receiving audio waves by an audio receiving device of the conventional system in FIG. 7; and

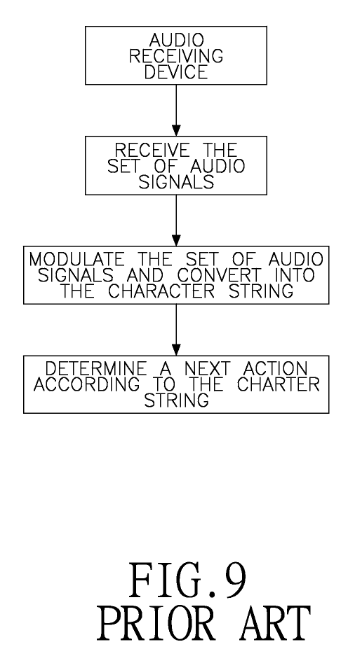

FIG. 10 is a chart diagram showing original audio signals and data therein on the frequency spectrum and audio signals and data therein done by lossy compression on the frequency spectrum in accordance with the prior art.

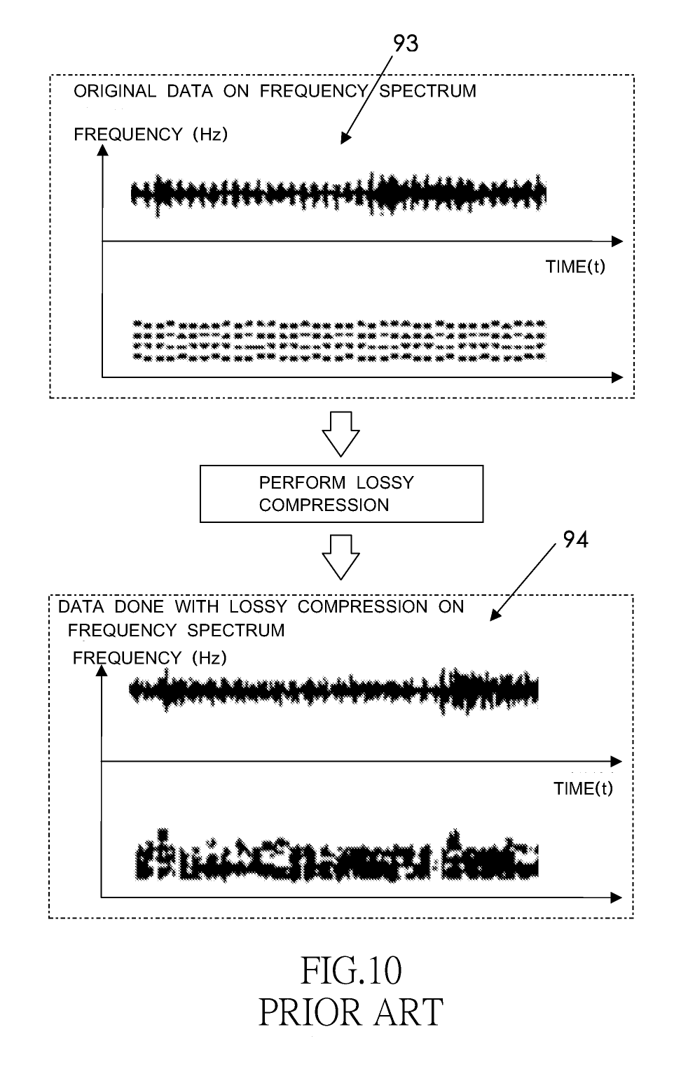

### DETAILED DESCRIPTION OF THE INVENTION

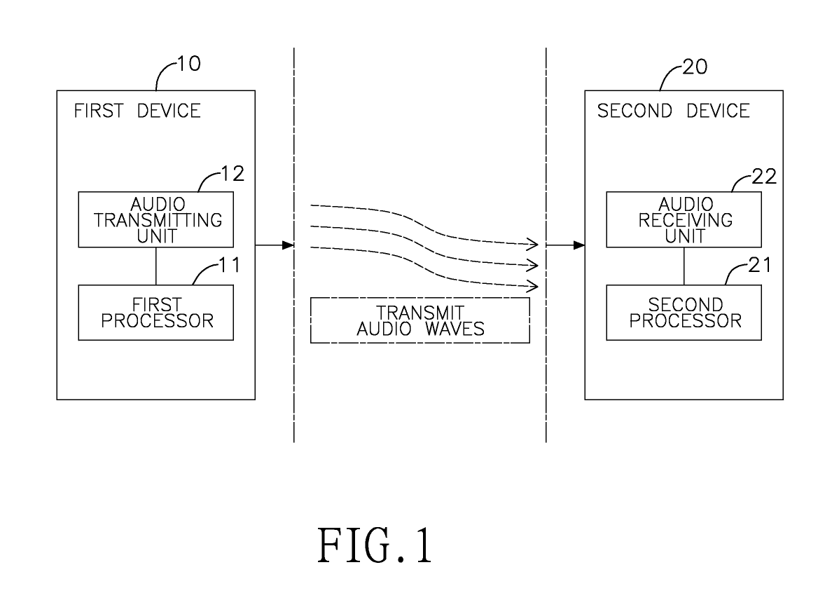

With reference to FIG. 1, an audio signal transmission system in accordance with the present invention has a first device 10 and a second device 20.

The first device 10 transmits a set of audio waves through a medium, such as air, to the second device 20. The set of audio waves indicates a set of continuous audio signals transmitted through the air, and can be generally referred to all kinds of sounds heard by human ears. In the present embodiment, each of the first device 10 and the second device 20 is an electronic device, such as a mobile device, a smart device, a computer or the like.

The first device 10 includes a first processor 11, an audio transmitting unit 12, and an input unit. The first processor 11 is connected to the audio transmitting unit 12 and the input unit, and stores information built in or pre-stored in the first processor 11 or inputted through the input unit. The first processor 11 reads a piece of information, converts the piece of information, and further performs data state conversion algorithm to generate a time-based byte sequence, adds a check code and a header to the byte sequence to generate a bit sequence. After reading the bit sequence, the first processor 11 modulates the bit sequence to a set of audio signals and the audio transmitting unit 12 transmits the set of audio signals through the air for the second device 20 to receive.

In the present embodiment, the first processor 11 performs data conversion on the piece of information to convert the piece of information into digital data, and further performs the data state conversion algorithm on the digital data to generate the time-based byte sequence.

The second device 20 includes a second processor 21 and an audio receiving unit 22. The second processor 21 is connected to the audio receiving unit 22. The audio receiving unit 22 serves to receive the set of audio signals transmitted from the first device 10 and sends the set of audio signals to the second processor 21 for the second processor 21 to perform audio signal processing or data recognition. After the second device 20 receives the set of audio signals containing the piece of information, the second processor 21 processes the set of audio signals with filtering and demodulation to acquire the time-based byte sequence, converts the byte sequence into readable data, and correctly reads the piece of information in the readable data according to the header and check code. As the byte sequence has time-based characteristics, the second processor 21 can rapidly and correctly read multiple pulse signals and acquire the piece of embedded information, not only increasing audio signal recognition but also enhancing accuracy and stability of the system.

In the present embodiment, the second processor 21 filters and demodulates the set of audio signals to acquire the time-based byte sequence through a band-pass filter and a Fast Fourier Transform (FFT) device.

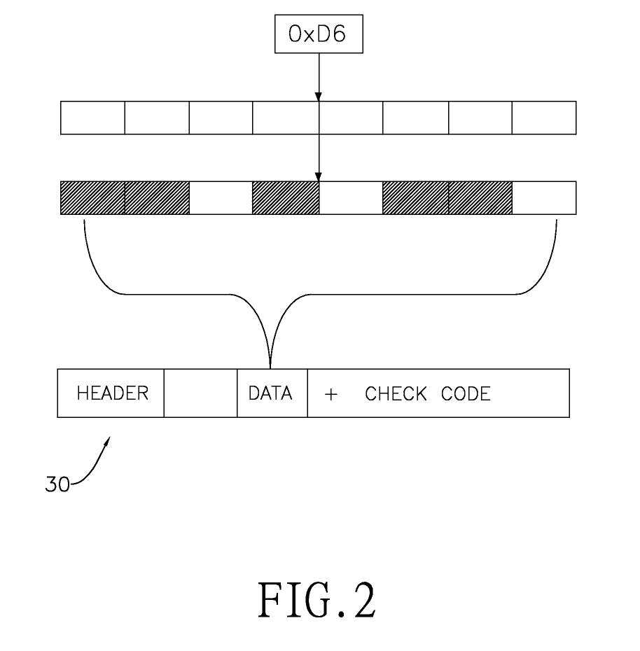

With reference to FIG. 2, data structures of information processed by the first device 10 are shown. The first processor 11 of the first device 10 reads the piece of information. The piece of information may be a character string, for example 0xD6 as shown in FIG. 2. When the piece of information is converted, the piece of information is converted into the digital data according to ASCII (American Standard Code for Information Interchange) codes corresponding to the character string. The digital data include a set of binary bits, such as “11010110”. The data state conversion algorithm is performed on the set of binary bits to generate a time-based byte sequence. In the present embodiment, the data state conversion algorithm is performed by the first processor 11 to sequentially determine the binary bits of the digital data according to binary values thereof. In the present embodiment, the first processor 11 sequentially determines the digital data in a direction from the most significant bit to the less significant bit of the byte sequence. When the first processor 11 reads a first bit of the digital data with a binary value “1”, a pulse signal appears at one time duration (t) in the time domain through a modulation process. Similarly, when the first processor 11 reads a second bit with the binary value “1”, a pulse signal appears at two time durations (2 t) in the time domain, and when the first processor 11 reads a third bit with the binary value “0”, no pulse signal appears at three time durations (3 t) in the time domain. Likewise, the entire time-based byte sequence can be generated according to the foregoing manner. The check code and a header are added to the byte sequence to constitute the bit sequence 30. The bit sequence is modulated by the first device 10 to generate a set of audio signals. In the present embodiment, the modulation process can be defined by a formula, Asin(2πft+θ), where A is amplitude, f is frequency, t is time and θ is phase angle.

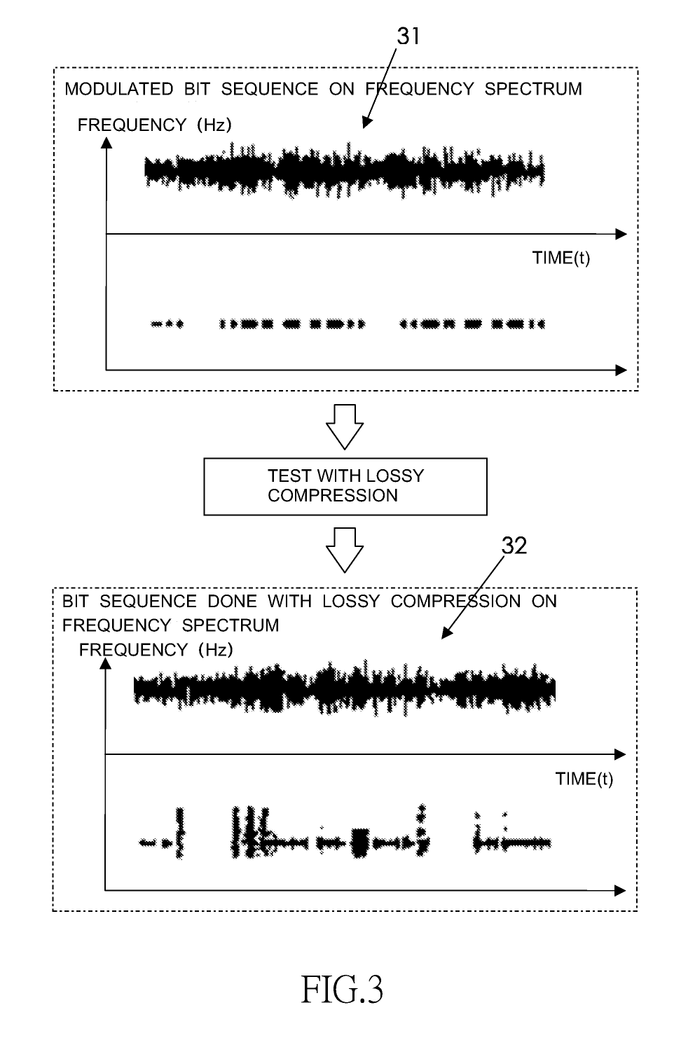

The reason why the bit sequence 30 can be still highly recognizable after modulation and compression can be explained as follows. With reference to FIG. 3, when the set of audio signals is represented by a form on an original frequency spectrum 31 to demonstrate the set of audio signals with the modulated bit sequence 30 and audio characteristics of the set of audio signals, the vertical and horizontal axes of the frequency spectrum respectively represent frequency (Hz) and time (t). When the first processor 11 performs lossy compression algorithm, such as HE-AAC 64 kbps, on the set of audio signals and audio characteristics thereof, the set of audio signals and audio characteristics thereof done with the lossy compression algorithm are shown on a frequency spectrum for lossy compression 32. Thus, although the set of audio signals done with lossy compression may still be obscure, the arrangement of the time-based byte sequence allows bits of the byte sequence to be mutually independent, and transmission throughput can be also greatly reduced after the lossy compression. Therefore, when reading and recognizing availability of the pulse signals, the second device 20 can still quickly and accurately read the piece of information. Even though the set of audio signals done with lossy compression becomes more obscure, the availability of the pulse signals can be promptly distinguished by adjusting the time duration (t) in the time domain of the FFT, such that the second device 20 can successfully transmit the set of audio signals containing the piece of information and modulate the set of audio signals to correctly read the piece of information after receiving the set of audio signals.

After modulating the bit sequence 30 to the set of audio signals, the first processor 11 of the first device 10 performs a data comparison process. The data comparison process is performed by the first processor 11 after the first processor 11 determines that the piece of information in the set of audio signals can be correctly read. If determining that the piece of information cannot be correctly read, the first processor 11 resumes data conversion by increasing a time parameter required for the data state conversion algorithm, and the time parameter may be the time duration in the time domain of Fourier Transform.

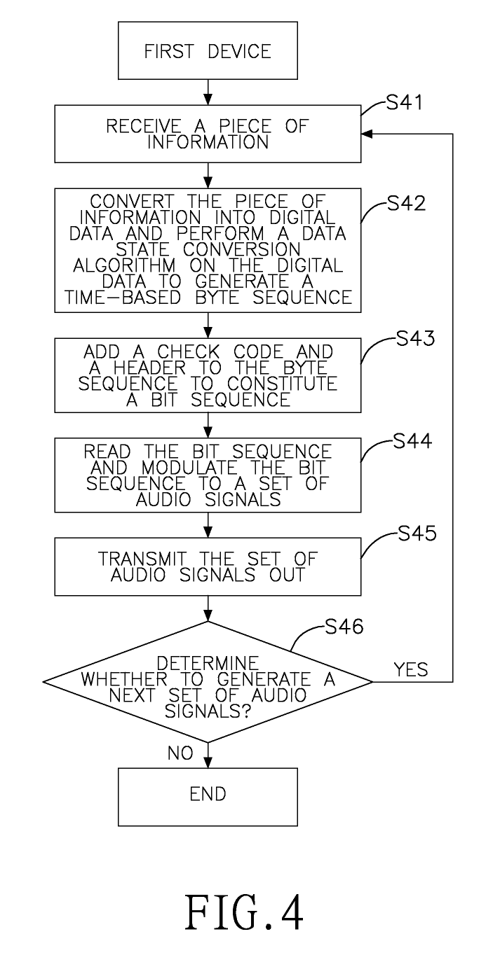

According to the foregoing description, a data processing method for the foregoing audio signal transmission system can be concluded and is performed when the first device 10 transmits a set of audio signals to the pairing second device 20. With reference to FIG. 4, the first device 10 performs the following steps.

Step S41: Receive a piece of information. The piece of information may be a character string.

Step S42: Convert the piece of information into digital data and perform a data state conversion algorithm on the digital data to generate a time-based byte sequence. In the present embodiment, when the piece of information is performed, the piece of information is converted into the digital data, such as binary data, and the data state conversion algorithm is performed on the digital data.

Step S43: Add a check code and a header to the byte sequence to constitute a bit sequence.

Step S44: Read the bit sequence and modulate the bit sequence to a set of audio signals.

Step S45: Transmit the set of audio signals to the second device 20 for the second device 20 to receive or store. In the present embodiment, the set of audio signals is further compressed and a data comparison process is performed on the set of audio signals. The data comparison process is performed after the piece of information in the set of audio signals is determined to be correctly readable. If the piece of information is determined to be not correctly readable, return to step 42 and adjust a parameter required by the data state conversion algorithm.

Step S46: Determine whether to generate a next set of audio signals. If positive, return to step S41.

Given the foregoing steps, the first device 10 can transmit audio signals to the second device 20. When the first device 10 receives the piece of information, converts the piece of information into the digital data, and performs the data state conversion algorithm to generate the time-based byte sequence, the second device 20 can constantly read out the piece of information according to the availability states of the pulse signals associated with the byte sequence.

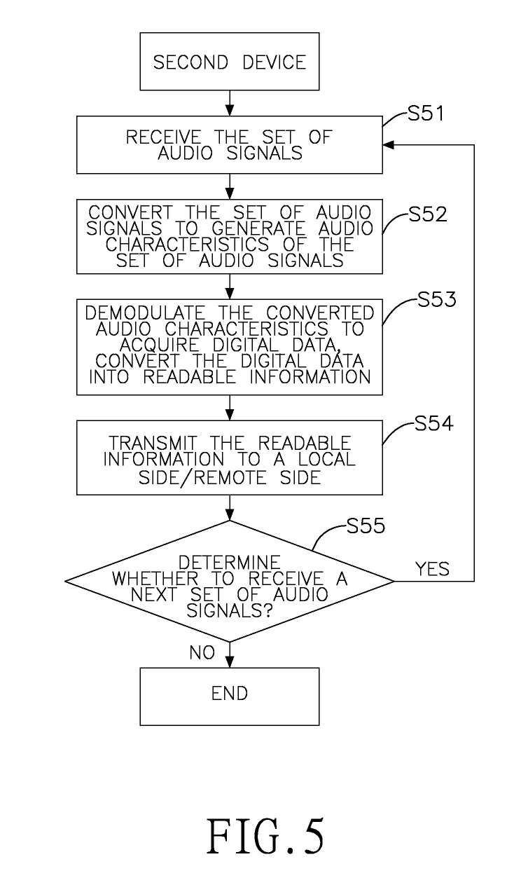

After the first device 10 transmits the set of audio signals to the second device 20 for the second device to receive, with reference to FIG. 5, the second device 20 performs the following steps.

Step S51: Receive the set of audio signals.

Step S52: Convert the set of audio signals to generate audio characteristics of the set of audio signals. In the present embodiment, the set of audio signals can be further filtered and converted. The second device 20 filters and demodulates the set of audio signals using a band-pass filter and a FFT device.

Step S53: Demodulate the converted audio characteristics to acquire digital data, convert the digital data into readable information and read the readable information. In the present embodiment, the readable information is a character string.

Step S54: Transmit the readable information to a local side/remote side.

Step S55: Determine whether to receive a next set of audio signals. If positive, return to step S51.

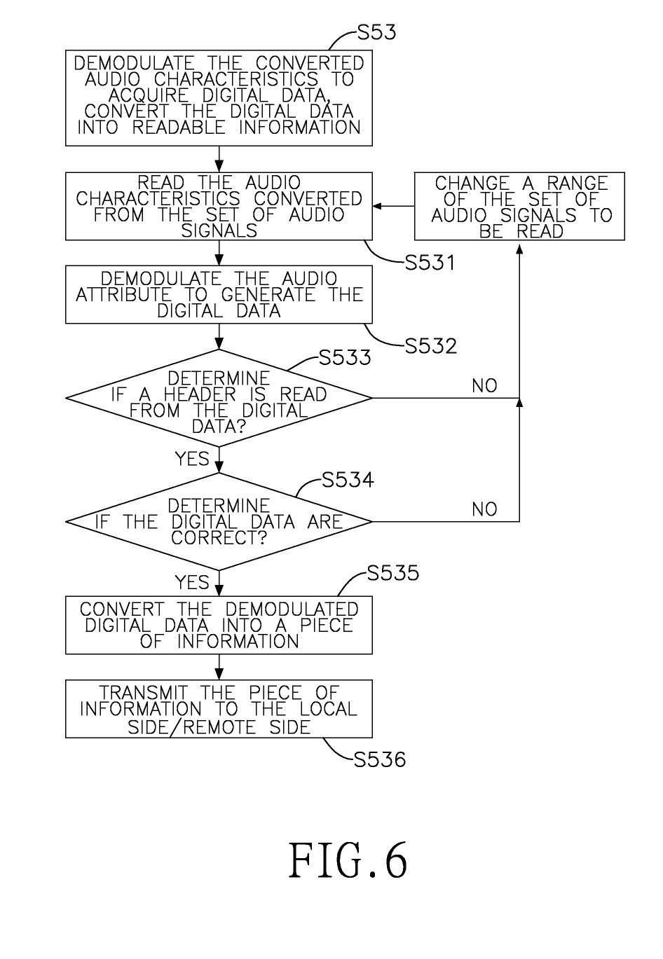

Given the foregoing steps, after receiving the set of audio signals, the second device 20 filters and demodulates the set of audio signals to acquire the time-based byte sequence, converts the byte sequence into the readable information, and read the readable information. When performing step S53, with reference to FIG. 6, the second device 20 further performs the following steps.

Step S531: Read the audio characteristics converted from the set of audio signals.

Step S532: Demodulate the audio characteristics to generate the digital data.

Step S533: Determine if a header is read from the digital data. If positive, perform step S534. Otherwise, perform step S537 and then step S531.

Step S534: Determine if the digital data are correct with a check code. If positive, perform step S535. Otherwise, perform step S537 and then step S531.

Step S535: Convert the demodulated digital data into a piece of information.

Step S536: Transmit the piece of information to the local side/remote side.

Step S537: Change a range of the set of audio signals to be read.

The present invention provides the foregoing time-based byte sequence featured by the availability states of pulse signal to allow that the second device 20 can still read the piece of information contained in the set of audio signals as long as pulse signals are still available after the set of audio signals is done with lossy compression. Accordingly, the issues of corrupted waveform or frequency of the original audio signals, error of reading correct information in the original audio signals, and failure and instability upon data transmission after the original audio signals are coded by lossy compression can be tackled.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A data processing method for an audio signal transmission system with enhanced audio signal recognition, wherein the audio signal transmission system includes a first device and a second device pairing with the first device, and when the first device transmits audio waves to the second device, the data processing method is performed by the first device and comprises steps of:
receiving a piece of information;
converting the piece of information into digital data and performing a data state conversion algorithm on the digital data to generate a time-based byte sequence;
adding a header to the byte sequence to constitute a bit sequence;
reading the bit sequence and modulating the bit sequence to a set of audio signals; and
transmitting the set of audio signals to the second device for the second device to receive.

2. The data processing method as claimed in claim 1, wherein the step of adding a header to the byte sequence has a step of adding the header and a check code to the byte sequence to constitute the bit sequence.

3. The data processing method as claimed in claim 1, wherein the step of transmitting the set of audio signals to the second device further has steps of:
compressing the set of audio signals and performing a data comparison process on the set of audio signals, wherein the data comparison process is performed after the piece of information in the set of audio signals is determined to be correctly readable, and when the piece of information is determined to be not correctly readable, returning to the step of converting the piece of information into digital data and performing a data state conversion algorithm and adjusting a parameter required by the data state conversion algorithm.

4. The data processing method as claimed in claim 1, wherein the piece of information is a character string.

5. The data processing method as claimed in claim 1, wherein the data state conversion algorithm sequentially determines binary bits of the digital data according to binary values of the digital data, and when reading any binary bit of the digital data with a value one, the data state conversion algorithm represents the bit with a pulse signal appearing at a corresponding time spot of a time domain through a modulation process.

6. The data processing method as claimed in claim 1, wherein when the first device transmits audio waves to the second device, the data processing method is performed by the second device and comprises steps of:
receiving the set of audio signals;
converting the set of audio signals to generate audio characteristics of the set of audio signals;
demodulating the converted audio characteristics to acquire digital data, converting the digital data into readable information, and reading the readable information; and
transmitting the readable information to a local side or a remote side.

7. The data processing method as claimed in claim 6, wherein the step of converting the set of audio signals has a step of filtering and converting the set of audio signals.

8. The data processing method as claimed in claim 7, wherein the step of demodulating the converted audio characteristics further has steps of:
reading the audio characteristics converted from the set of audio signals;
demodulating the audio characteristics to generate the digital data;
determining if a header is read from the digital data;
when the header is read, determining if the digital data are correct with a check code;
when the digital data are correct, converting the demodulated digital data into a piece of information; and
transmitting the piece of information to the local side or the remote side.

9. The data processing method as claimed in claim 8, wherein in the step of determining if the header is read from the digital data, when the header is not read, changing a range of the set of audio signals to be read and returning to the step of reading the audio characteristics converted from the set of audio signals.

10. The data processing method as claimed in claim 9, wherein in the step of determining if the digital data are correct with a check code, when the digital data are not correct, changing a range of the set of audio signals to be read and returning to the step of reading the audio characteristics converted from the set of audio signals.

11. An audio signal transmission system with enhanced audio signal recognition, comprising:
a first device having:
an audio transmitting unit; and
a first processor connected to the audio transmitting unit and transmitting audio signals through the audio transmitting unit;
a second device having:
an audio receiving unit receiving the audio signals; and
a second processor connected to the audio receiving unit, receiving the audio signals transmitted from the audio receiving unit, and processing the audio signals or recognizing data contained in the audio signals;
wherein
the first processor of the first device performs a first data processing method and the first data processing method includes steps of:
receiving a piece of information;
converting the piece of information into digital data and performing a data state conversion algorithm on the digital data to generate a time-based byte sequence;
adding a header to the byte sequence to constitute a bit sequence;
reading the bit sequence and modulating the bit sequence to a set of audio signals; and
transmitting the set of audio signals to the second device for the second device to receive; and
the second processor of the second device performs a second data processing method and the second data processing method includes steps of:
receiving the set of audio signals;
converting the set of audio signals to generate audio characteristics of the set of audio signals;
demodulating the converted audio characteristics to acquire digital data, converting the digital data into readable information, and reading the readable information; and
transmitting the readable information to a local side or a remote side.
